(19) United States
(12) Patent Application Publication
(10) Pub. No.: US 2019/0369431 A1
(43) Pub. Date: Dec. 5, 2019

(54) DISPLAY PANEL AND DISPLAY DEVICE

(71) Applicant: HON HAI PRECISION INDUSTRY CO., LTD., New Taipei (TW)

(72) Inventor: TE-WEI CHAN, Hsinchu (TW)

(21) Appl. No.: 16/369,020

(22) Filed: Mar. 29, 2019

(30) Foreign Application Priority Data
Jun. 4, 2018 (CN) 201810564650.7

(51) Int. Cl. G02F 1/1339

(52) U.S. Cl. CPC G02F 1/13394; G02F 1/1368

(57) ABSTRACT

A display panel defining a display area and a border area surrounding the display area. The display panel includes a color filter substrate, a TFT substrate facing the color filter substrate, and a liquid crystal layer and a sealant between the color filter substrate and the TFT substrate. The sealant is in the border area and seals the liquid crystal layer between the color filter substrate and the TFT substrate. The display panel further includes at least one first retaining wall located in the sealant and surrounding the display area, and the first retaining wall connects the color filter substrate and the TFT substrate. A display device using the display panel is also provided.

### FIELD

The subject matter herein generally relates to displays.

### BACKGROUND

A liquid crystal display device has advantages of light weight, thinness, low power consumption, and low radiation, and is widely used, it has gradually become the mainstream of display devices. Liquid crystal displays have high transmittance, large size, low power consumption, and are low cost.

Generally, the liquid crystal display panel includes a color filter substrate, a thin film transistor (TFT) substrate, a liquid crystal layer between the color filter substrate and the TFT substrate, and a sealant. The sealant is located in a border area of the liquid crystal display panel to constrain the liquid crystals in a liquid crystal cell. However, in order to enhance a bonding ability of the color filter substrate and the TFT substrate, a large amount of the sealant is used, which makes liquid crystal display panels with narrow borders difficult to achieve.

Therefore, there is room for improvement in the art.

### BRIEF DESCRIPTION OF THE DRAWINGS

Implementations of the present disclosure will now be described, by way of embodiment, with reference to the attached figures.

FIG. 1 is a top planar view of a display panel according to an embodiment.

FIG. 2 is a cross-sectional view along line II-II of FIG. 1 after the color filter substrate and the TFT substrate are assembled.

FIG. 3 is a cross-sectional view along line II-II of FIG. 1 before the color filter substrate and the TFT substrate are assembled.

FIG. 4 is a structural view of a first retaining wall of the display panel of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

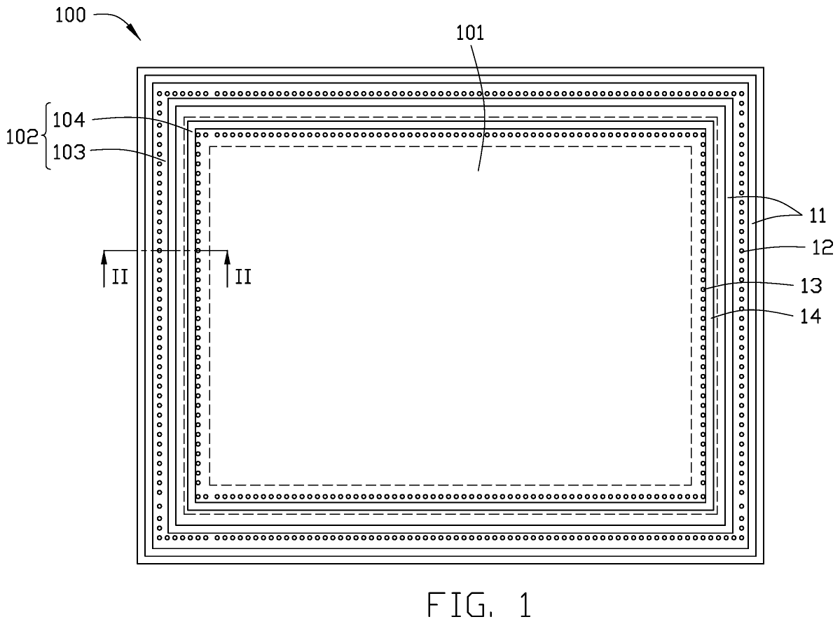

As shown in FIG. 1, a display panel 100 defines a display area 101 and a border area 102 surrounding the display area 101. The border area 102 is an area covered with a black light-shielding layer, and is not opaque. The border area 102 includes a sealant area 103 and a non-sealant area 104. The sealant area 103 surrounds the non-sealant area 104. The non-sealant area 104 is adjacent to and surrounds the display area 101.

As shown in FIG. 1, the display panel 100 includes at least one first retaining wall 11 located in the sealant area 103 and surrounding the display area 101, a plurality of first spacers 12 spaced apart from each other in the sealant area 103 and surrounding the display area 101, at least one second retaining wall 14 located in the non-sealant area 104 and surrounding the display area 101 and a plurality of second spacers 13 spaced apart from each other located in the non-sealant area 104 and surrounding the display area 101. The at least one first retaining wall 11 and the at least one second retaining wall 14 are closed rectangles surrounding the display area 101. In another embodiment, the first retaining wall 11 may be four strip-shaped retaining walls that are not closed around the display area 101, and the second retaining wall 14 may be four long strip-shaped retaining walls that are not closed around the display area 101.

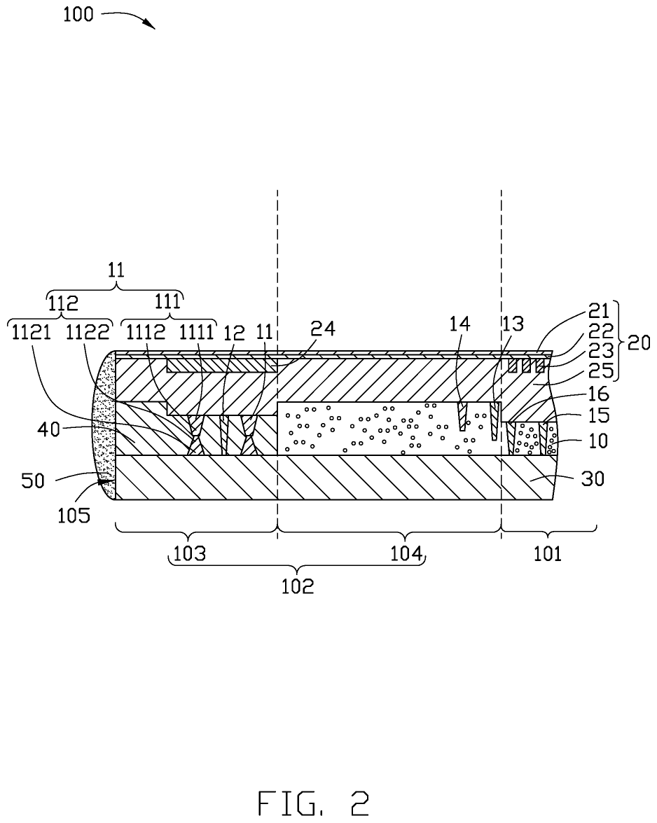

As shown in FIG. 2, the display panel 100 includes a color filter substrate 20 and a TFT substrate 30 facing the color filter substrate 20, a liquid crystal layer 10 between the color filter substrate 20 and the TFT substrate 30, and a sealant 40 between the color filter substrate 20 and the TFT substrate 30 in the sealant area 103 and seals the liquid crystal layer 10 between the color filter substrate 20 and the TFT substrate 30.

As shown in FIG. 2, the at least one first retaining wall 11 is located in the sealant 40. The first retaining wall 11 includes a first portion 111 and a second portion 112 connected to the first portion 111. The first portion 111 and the second portion 112 are both disposed around the display area 101. The first portion 111 includes a first top end 1111 and away from the second portion 112 and a first bottom end 1112 connected to the second portion 112, the second portion 112 includes a second top end 1122 connected to the first portion 111 and a second bottom end 1121 away from the first portion 111. The first top end 1111 of the first portion 111 is fixed to the color filter substrate 20, and the second bottom end 1121 of the second portion 112 is fixed to the TFT substrate 30.

A cross-sectional area defined by the first top end 1111 of the first portion 111 along a direction parallel to the TFT substrate 30 is larger than a cross-sectional area defined by the first bottom end 1112 of the first portion 111 along the direction parallel to the TFT substrate 30. A cross-sectional area defined by the second bottom end 1121 of the second portion 112 along the direction parallel to the TFT substrate 30 is larger than a cross-sectional area defined by the second top end 1122 of the second portion 112 along the direction parallel to the TFT substrate 30.

The cross-sectional area of the first bottom end 1112 of the first portion 111 along the direction parallel to the TFT substrate 30 is greater than the cross-sectional area of the second top end 1122 of the second portion 112 along the direction parallel to the TFT substrate 30. A longitudinal section of the first portion 111 along a thickness direction of the display panel 100 and a longitudinal section of the second portion 112 along the thickness direction of the display panel 100 are both trapezoidal shaped. Here, the longitudinal section along the thickness direction of the display panel 100 is a longitudinal section perpendicular to the direction of the TFT substrate 30.

In an embodiment, the two ends of the first retaining wall 11 fixed to the color filter substrate 20 and the TFT substrate 30 both have a lager cross-sectional area, so that an area supporting the color filter substrate 20 and the TFT substrate 30 is increased. Thus, a width of the sealant 40 can be narrowed to achieve a narrow border design.

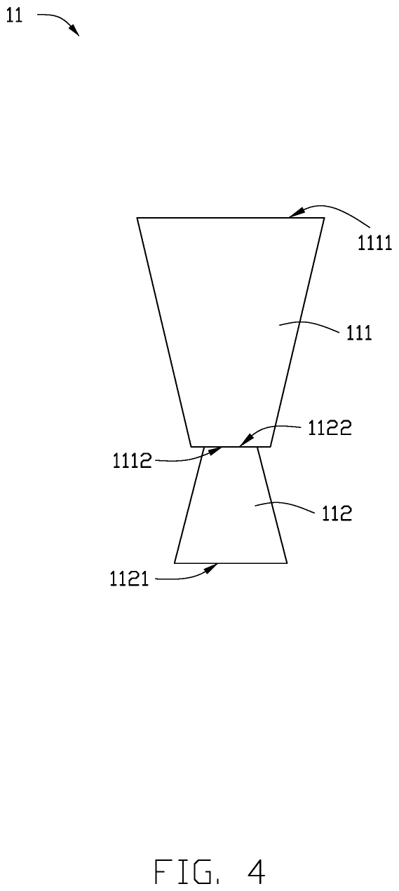

As shown in FIG. 4, a longitudinal section of the first portion 111 along a thickness direction of the display panel 100 and the longitudinal section of the second portion 112 along a thickness direction of the display panel 100 are both trapezoidal. That is, the first portion 111 is tapered from its first top end 1111 to its first bottom end 1112, the second portion 112 is tapered from its second bottom end 1121 to its second top end 1122. The cross-sectional area of the first bottom end 1112 of the first portion 111 along the direction parallel to the TFT substrate 30 is greater than the cross-sectional area of the second top end 1122 of the second portion 112 along the direction parallel to the TFT substrate 30. That is, the first bottom end 1112 of the first portion 111 is thicker, and the second top end 1122 of the second portion 112 is thinner, so that the first portion 111 of the first retaining wall 11 and the second portion 112 of the first retaining wall 11 can be accurately aligned. When the color filter substrate 20 and the TFT substrate 30 are vibrated or squeezed, displacement between the two is less likely to occur, and the reliability of the connection between the two can be effectively improved.

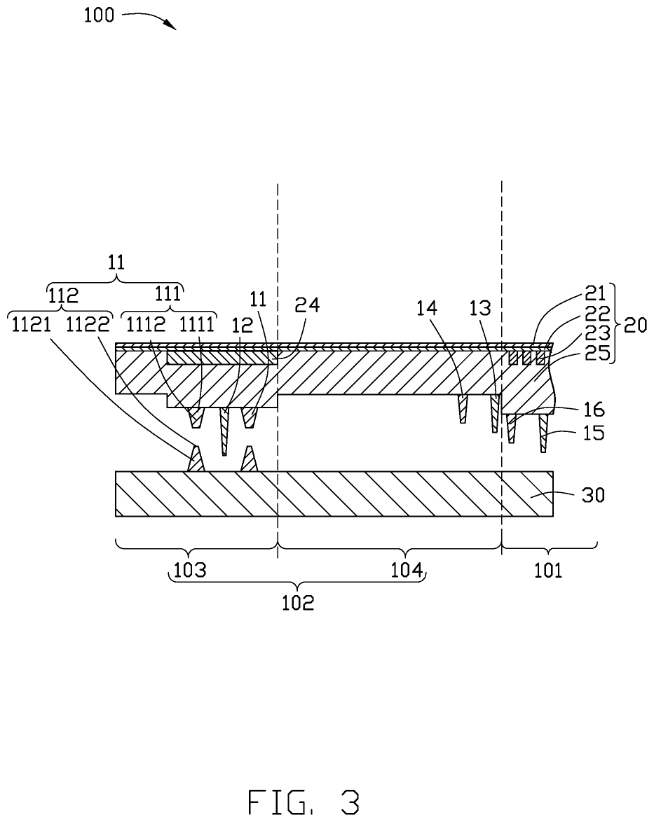

As shown in FIGS. 2 and 3, the display panel 100 further includes a plurality of third spacers 15 in the display area 101 and a plurality of fourth spacers 16 in the display area 101. In an embodiment, the first spacers 12, the second spacers 13, the third spacers 15, and the fourth spacers 16 are columnar spacers spaced apart from each other.

As shown in FIGS. 2 and 3, the color filter substrate 20 includes a glass substrate 21, a black matrix 22 on a surface of the glass substrate 21, a plurality of color filter patterns 23 and a plurality of dummy patterns 24 both on a surface of the black matrix 22 away from the glass substrate 21, and a flat layer 25 covering the color filter patterns 23 and the dummy patterns 24. The color filter patterns 23 and the dummy patterns 24 have the same thickness. The color filter patterns 23 are in the display area 101, and the dummy patterns 24 are in the sealant area 103. The dummy patterns 24 and the color filter patterns 23 are not in the non-sealant area 104. Thus, the surface of the flat layer 25 forming the first retaining wall 11 and the first spacers 12 in the sealant area 103 and the surface of the flat layer 25 forming the third spacers 15 and the fourth spacers 16 in the display area 101 have a same height, and the height is greater than the height of the surface of the flat layer 25 forming the second retaining wall 14 and the second spacers 13 in the non-sealant area 104.

As shown in FIG. 3, before assembly of the color filter substrate 20 and the TFT substrate 30, a height of each first spacers 12 in a natural state, a height of each second spacer 13 in the natural state, and a height of each third spacers 15 are in the natural state are equal, a height of the first retaining wall 11 in the natural state, a height of the second retaining wall 14 in the natural state, a height of each fourth spacers 16 in the natural state are equal, and the height of each first spacers 12 in the natural state, the height of each second spacers 13 in the natural state, the height of each third spacers 15 in the natural state is greater than the height of the first retaining wall 11 in the natural state, the second retaining wall 14 is in the natural state and the height of each fourth spacers 16 in the natural state.

In an embodiment, when the color filter substrate 20 and the TFT substrate 30 are assembled, the first spacers 12 having a larger height in the sealant area 103 and the third spacers 15 having a larger height in the display area 101 are firstly contacted with the TFT substrate30. The first retaining wall 11 having a smaller height in the sealant area 103, the fourth spacers 16 having a smaller height in the display area 101, the second retaining wall 14 and the second spacers 13 in the non-sealant area 104 extend toward the TFT substrate 30 and do not contact the TFT substrate 30. When the display panel 100 is further pressed, the first spacers 12 in the sealant area 103 and the third spacers 15 in the display area 101 are compressed to provide a main support, the first portion 111 of the first retaining wall 11 and the second portion 112 of the first retaining wall 11 are aligned and connected to each other in the sealant area 103, and the end of each fourth spacers 16 in the display area 101 contacts the TFT substrate 30 to provide further support.

As shown in FIG. 2, after assembly of the color filter substrate 20 and the TFT substrate 30, the first spacers 12 and the third spacers 15 having a larger height provide a main support to maintain a thickness between the color filter substrate 20 and the TFT substrates 30, and the first retaining wall 11 and the fourth spacers 16 having a smaller height provide a further support. In the non-sealant area 104, one ends of each second spacers 13 and the second retaining wall 14 are fixed to the color filter substrate 20, and the other ends of each second spacers 13 and the second retaining wall 14 are suspended. That is, the other ends of each second spacer 13 and the second retaining wall 14 both extend toward the TFT substrate 30 and do not contact the TFT substrate 30. That is, a compression deformation amount of each first spacer 12 along the thickness direction of the display panel 100 is greater than a compression deformation amount of the first retaining wall 11 along the thickness direction of the display panel 100, and a compression deformation amount of each third spacer 15 along the thickness direction of the display panel 100 is larger than a compression deformation amount of each fourth spacer 16 in the thickness direction of the display panel 100. In addition, the second spacers 13 and the second retaining wall 14 are used to guide the flowing liquid crystal to reduce or avoid a leakage of the sealant 40 caused by an impact of the liquid crystal flowing on the sealant 40.

In an embodiment, the color filter substrate 20 further includes a first electrode layer (not shown), and the first electrode layer may be a common electrode made of a transparent conductive material, such as indium tin oxide (ITO) or Indium-doped Zinc Oxide (IZO). The TFT substrate 30 includes a plurality of scan lines, a plurality of data lines intersecting with the scan lines, a plurality of thin film transistors arranged in a matrix, and a second electrode layer defining a plurality of pixel electrodes. A minimum area defined by two adjacent scan lines and two adjacent data lines defines one pixel. Each pixel includes one pixel electrode and one thin film transistor. A driving electric field is formed between the first electrode layer and the second electrode layer to drive the liquid crystal molecules in the liquid crystal layer 10 to rotate.

As shown in FIG. 2, the display panel 100 has a side surface 105 surrounding and connecting the border area 102. The side surface 105 is covered with an adhesive layer 50. The adhesive layer 50 covers a connecting gap between the sealant 40 and the color filter substrate 20 and a connecting gap between the sealant 40 and the TFT substrate 30. In this embodiment, by providing the adhesive layer 50 on the side surface 105 of the display panel 100 surrounding and connecting the border area 102, the connection between the color filter substrate 20 and the TFT substrate 30 is further enhanced, and the width of the sealant 40 can be further reduced, thereby achieving a narrow border design.

The adhesive layer 50 includes at least one of a waterproof adhesive layer, an antistatic adhesive layer, a light shielding adhesive layer or a buffer adhesive layer having a mechanical buffering function. Thus, the display panel 100 can simultaneously realize a narrow border and at least one of functions of waterproofing, antistatic, shading, or enhancing mechanical strength. In the case where the adhesive layer 50 is a combination of two or more of a waterproof adhesive layer, an antistatic adhesive layer, a light shielding adhesive layer, and a buffer adhesive layer, a coating order of each rubber layer is not limited.

An embodiment of the present disclosure further provides a display device. The display device includes a main body and the display panel 100 in the main body. The display device may be a flat-panel TV, a tablet, a mobile phone, an advertisement display screen, an information display screen, a car display, a smart watch, a smart bracelet, or the like.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A display panel defining a display area and a border area surrounding the display area, the display panel comprising:
a color filter substrate;
a thin film transistor (TFT) substrate facing the color filter substrate;
a liquid crystal layer between the color filter substrate and the TFT substrate;
a sealant in the border area, the sealant sealing the liquid crystal layer between the color filter substrate and the TFT substrate; and
at least one first retaining wall in the sealant and surrounding the display area, the first retaining wall being connected to the color filter substrate and the TFT substrate.

2. The display panel according to claim 1, wherein the first retaining wall comprises a first portion and a second portion connected to the first portion, the first portion comprises a first top end away from the second portion and a first bottom end connected to the second portion, the second portion comprises a second top end connected to the first portion and a second bottom end away from the first portion, and the first top end of the first portion is fixed to the color filter substrate, the second bottom end of the second portion is fixed to the TFT substrate.

3. The display panel according to claim 2, wherein a cross-sectional area defined by the first top end of the first portion along a direction parallel to the TFT substrate is larger than a cross-sectional area defined by the first bottom end of the first portion along the direction parallel to the TFT substrate, and a cross-sectional area defined by the second bottom end of the second portion along the direction parallel to the TFT substrate is larger than a cross-sectional area defined by the second top end of the second portion along the direction parallel to the TFT substrate.

4. The display panel according to claim 3, wherein the cross-sectional area of the first bottom end of the first portion along the direction parallel to the TFT substrate is greater than the cross-sectional area of the second top end of the second portion along the direction parallel to the TFT substrate.

5. The display panel according to claim 3, wherein a longitudinal section of the first portion along a thickness direction of the display panel and a longitudinal section of the second portion along the thickness direction of the display panel are both trapezoidal shaped.

6. The display panel according to claim 1, further comprising a plurality of first spacers spaced apart from each other in the sealant, wherein a compressive deformation amount of each of the plurality of first spacers is greater than a compressive deformation amount of the first retaining wall along the thickness direction of the display panel.

7. The display panel according to claim 6, wherein the border area comprises a sealant area and a non-sealant area, the sealant area surrounds the non-sealant area, and the non-sealant area is adjacent to and surrounds the display area, the sealant is disposed in the sealant area, and the display panel further comprises at least one second retaining wall disposed in the non-sealant area and surrounds the display area, one end of the second retaining wall is fixed to the color filter substrate, and the other end of the second retaining wall extends toward the TFT substrate and does not contact the TFT substrate.

8. The display panel according to claim 7, further comprising a plurality of second spacers spaced apart from each other in the non-sealant area, wherein one end of each of the plurality of second spacers is fixed to the color filter substrate, and the other end of each of the plurality of second spacers extends toward the TFT substrate and does not contact the TFT substrate.

9. The display panel according to claim 1, wherein the display panel has a side surface surrounding and connecting the border area, and the side surface is coated with an adhesive layer.

10. A display device, comprising a main body and a display panel in the main body, the display panel defining a display area and a border area surrounding the display area, the display panel comprising:
a color filter substrate;
a thin film transistor (TFT) substrate facing the color filter substrate;
a liquid crystal layer between the color filter substrate and the TFT substrate;
a sealant in the border area, the sealant sealing the liquid crystal layer between the color filter substrate and the TFT substrate; and
at least one first retaining wall in the sealant and surrounding the display area, the first retaining wall being connected to the color filter substrate and the TFT substrate.

11. The display panel according to claim 10, wherein the first retaining wall comprises a first portion and a second portion connected to the first portion, the first portion comprises a first top end away from the second portion and a first bottom end connected to the second portion, the second portion comprises a second top end connected to the first portion and a second bottom end away from the first portion, the first top end is fixed to the color filter substrate, and the second bottom end is fixed to the TFT substrate.

12. The display panel according to claim 11, wherein a cross-sectional area defined by the first top end of the first portion along a direction parallel to the TFT substrate is larger than a cross-sectional area defined by the first bottom end of the first portion along the direction parallel to the TFT substrate, and a cross-sectional area defined by the second bottom end of the second portion along the direction parallel to the TFT substrate is larger than a cross-sectional area defined by the second top end of the second portion along the direction parallel to the TFT substrate.

13. The display panel according to claim 12, wherein the cross-sectional area of the first bottom end of the first portion along the direction parallel to the TFT substrate is greater than the cross-sectional area of the second top end of the second portion along the direction parallel to the TFT substrate.

14. The display panel according to claim 12, wherein a longitudinal section of the first portion along a thickness direction of the display panel and a longitudinal section of the second portion along the thickness direction of the display panel are both trapezoidal shaped.

15. The display panel according to claim 10, further comprising a plurality of first spacers spaced apart from each other in the sealant, wherein a compressive deformation amount of each of the plurality of first spacers is greater than a compressive deformation amount of the first retaining wall along the thickness direction of the display panel.

16. The display panel according to claim 15, wherein the border area comprises a sealant area and a non-sealant area, the sealant area surrounds the non-sealant area, and the non-sealant area is adjacent to and surrounds the display area, the sealant is disposed in the sealant area, and the display panel further comprises at least one second retaining wall disposed in the non-sealant area and surrounds the display area, one end of the second retaining wall is fixed to the color filter substrate, and the other end of the second retaining wall extends toward the TFT substrate and does not contact the TFT substrate.

17. The display panel according to claim 16, further comprising a plurality of second spacers spaced apart from each other in the non-sealant area, wherein one end of each of the plurality of second spacers is fixed to the color filter substrate, and the other end of each of the plurality of second spacers extends toward the TFT substrate and does not contact the TFT substrate.

18. The display panel according to claim 10, wherein the display panel has a side surface surrounding and connecting the border area, and the side surface is coated with an adhesive layer.
